(19) United States
(12) Patent Application Publication
(10) Pub. No.: US 2009/0129282 A1
(43) Pub. Date: May 21, 2009

(54) Method and apparatus for measuring quality of VoIP call

(75) Inventors: Byung-joon Lee, Daejeon-si (KR); Seung-hyun Yoon, Daejeon-si (KR); Hyung-seok Chung, Daejeon-si (KR); Sun-me Kim, Daejeon-si (KR); Ki-won Kim, Daejeon-si (KR); Byeong-sik Kim, Daejeon-si (KR); Hyun-soon Nam, Daejeon-si (KR); Han-sol Park, Busan-si (KR); In-sang Choi, Daejeon-si (KR); Tae-hyun Kwon, Andong-si (KR); Yon-hyeon Jeong, Daejeon-si (KR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Electronics and Telecommunications Research Institute

(21) Appl. No.: 12/221,077

(22) Filed: Jul. 30, 2008

(30) Foreign Application Priority Data
Nov. 20, 2007 (KR) 10-2007-0118659

(51) Int. Cl. H04L 12/26

(52) U.S. Cl. 370/252

(57) ABSTRACT

Provided are a method and an apparatus for periodically measuring speech quality in a voice over Internet protocol (VoIP) terminal while a VoIP call between VoIP terminals is in progress. The method comprises: receiving summary information regarding traffic sent from an opposite VoIP terminal; and evaluating speech quality by comparing the summary information with actually received information regarding the traffic sent from the opposite VoIP. Accordingly, each VoIP terminal can precisely evaluate the speech quality periodically and send the evaluation result to each other.

### CROSS REFERENCE TO RELATED APPLICATIONS

This application claims priority from Korean Patent Application No. 10-2007-0118659, filed on Nov. 20, 2007, the disclosure of which is incorporated herein in its entirety by reference.

### BACKGROUND OF THE INVENTION

1. Field of the Invention

The present invention relates to a communication terminal, and more particularly, to a method and an apparatus for measuring speech quality of a voice over Internet protocol (VoIP) terminal.

This work was partly supported by the IT R&D program of Ministry of Information and Communication (MIC)/Institute for Information Technology Advancement (IITA) [2005-S-097-03, Development of BcN Integrated Network Control and QoS/TE Management Technology]

2. Description of the Related Art

Voice over Internet protocol (VoIP) is a technology that transmits and receives audio data over the Internet or a computer network for a voice call like a telephone call. That is, the VoIP technology provides functions of the conventional telephone through the Internet. A user needs session initiation protocol (SIP) telephone program implemented in software or a VoIP telephone apparatus implemented in hardware to make a call through VoIP, and a VoIP terminal is based on software or hardware which is implemented for the purpose of supporting a voice call by using the VoIP technology.

Recently, as various communication networks are incorporated into an Internet protocol (IP)-based packet switching network, a VoIP application technology is actively used to enable a voice call across an IP network.

While in the conventional voice call based on a public switched telephone network (PSTN), an exchange can ensure adequate speech quality of individual calls, a VoIP call based on the Internet is hard to guarantee a constant quality of service on the Internet path which traffic for the call passes through. Thus, a voice call using VoIP needs a constant monitoring of whether a specific speech quality level is adequately ensured.

Generally, methods of monitoring a status of traffic in a particular application program, which is executed on the Internet, include a whole inspection method based on passive monitoring and a sample inspection method.

However, a whole inspection method is impossible to be realized due to an increase in Internet speed which causes a problem of scalability, and a sample inspection method cannot ensure the accuracy of measurement results since it is not possible to monitor all traffic on the Internet.

To solve the problems mentioned above, there have been research activities for the measurement of speech quality of a VoIP terminal. However, since information such as loss, delay or jitter in traffic for delivering voice data is measured in aggregate or on average in such conventional studies, it is hard to measure speech quality precisely while the VoIP call is in progress, or, if there is a problem, how long the problem lasts.

In other words, the conventional methods of measuring speech quality of a VoIP terminal provide only the general and coarse information about traffic that is generated in the progress of a VoIP call, and thus it is not possible to obtain detailed information regarding the speech quality.

### SUMMARY OF THE INVENTION

The present invention provides a method and an apparatus for periodically measuring speech quality in a voice over Internet protocol (VoIP) terminal while a VoIP call between VoIP terminals is in progress.

The present invention further provides a method and an apparatus for measuring a two-way speech quality by converting speech quality measurement result into a format that can be transmitted to the outside.

Additional aspects of the invention will be set forth in the description which follows, and in part will be apparent from the description, or may be learned by practice of the invention.

The present invention discloses a method of measuring speech quality of a voice over Internet protocol (VoIP) call, the method comprising: receiving summary information regarding traffic sent from an opposite VoIP terminal; and evaluating speech quality by comparing the summary information with actually received information regarding the traffic sent from the opposite VoIP terminal.

The evaluated speech quality may be stored in a data structure in the form of a histogram.

The method may further comprise: converting the stored speech quality into a format that can be transmitted to the outside in a manner that the converted speech quality includes a call identification (call ID), which is assigned to each voice call, and a speech quality measurement result.

In evaluating the speech quality, a transmission delay time may be calculated by comparing a time at which the opposite VoIP terminal sends the summary information with a time at which the receiving VoIP terminal receives the summary information, a transmission delay variance may be calculated by comparing the calculated transmission delay with a previous transmission delay and the lost bytes and packets of traffic may be calculated by comparing the numbers of bytes and packets of the sent traffic with the numbers of bytes and packets of traffic that has been received since the previous summary information was received.

The present invention also discloses an apparatus for measuring speech quality of a VoIP call, the apparatus comprising: a summary information receiving unit which receives summary information regarding traffic sent from an opposite VoIP terminal; and a speech quality evaluating unit which evaluates the speech quality by comparing the received summary information with actually received information of the traffic sent from the opposite VoIP terminal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a voice over Internet protocol (VoIP) terminal network according to an embodiment of the present invention.

FIG. 2 is a flowchart illustrating a method of measuring speech quality of a VoIP call according to an embodiment of the present invention.

FIG. 3 is a block diagram of an apparatus for measuring speech quality of a VoIP call according to an embodiment of the present invention.

FIG. 4 shows an example of converting a result of measuring speech quality of a VoIP call into a format for external transmission according to an embodiment of the present invention.

### DETAILED DESCRIPTION OF EXEMPLARY EMBODIMENTS

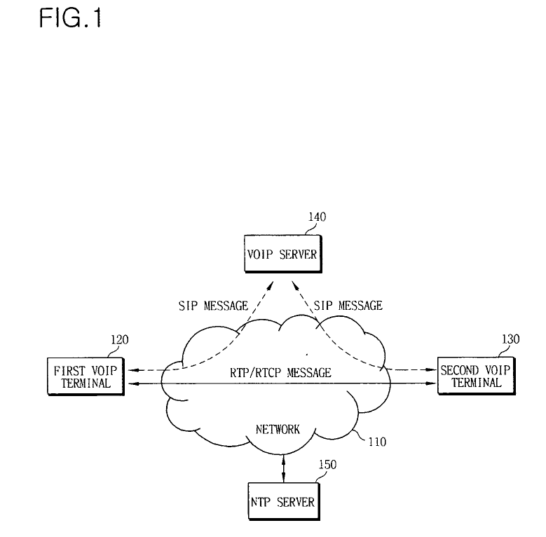

FIG. 1 is a voice over Internet protocol (VoIP) terminal network according to an embodiment of the present invention. Referring to FIG. 1, to make a voice call using VoIP through a first VoIP terminal 120 and a second VoIP terminal 130, the first VoIP terminal 120 can initiate or end a call to the second VoIP terminal 130 using session initiation protocol (SIP).

A series of SIP messages to initiate or end a call may be relayed by a VoIP server 140, or may be directly transferred between the first and second VoIP terminals. Moreover, when real time protocol (RTP) is used for voice traffic transmission, a sender report (SR) of real time control protocol (RTCP) which interworks with RTP is used for periodic summary information transmission. The summary information includes the time to send the summary information, and the numbers of bytes and packets of traffic which is sent after previous summary information was sent.

The second VoIP terminal 130 in a receiving side can assess speech quality of VoIP traffic that has been received since the last reception of traffic summary information until the present reception of the traffic summary information included in the SR. When the call is finished, the speech quality measurement result obtained from each VoIP terminal 120 and 130 can be transmitted to an external server by using a BYE/OK message of SIP or additional protocol. The external server collects the transmitted speech quality measurement results and generates the speech quality result of two-way communications with respect to a particular voice call.

Each of the first and second VoIP terminals 120 and 130 needs to set the present time accurately in advance, with an error less than 20 ms, by communicating with a network time protocol (NTP) server 150, which is located in the middle between the terminals 120 and 130, through the use of NTP, in order to obtain the correct time to send the summary information. NTP is a protocol used to synchronize clock times in a network of computers.

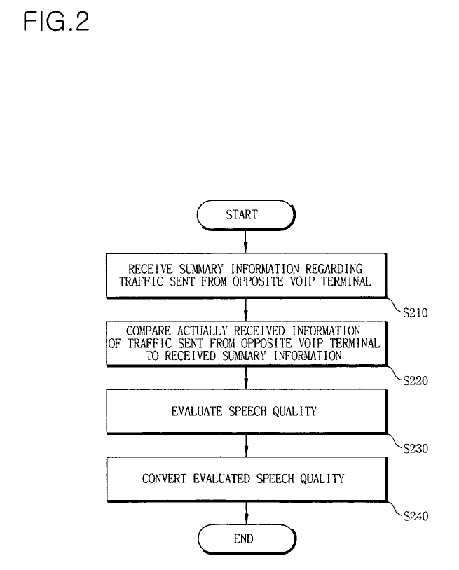

FIG. 2 is a flowchart illustrating a method of measuring speech quality of a VoIP call according to an embodiment of the present invention.

A VoIP terminal periodically sends an opposite VoIP terminal summary information regarding traffic from the time of initiating a call until the end of the call. That is, a VoIP terminal periodically receives summary information regarding traffic that has been sent from the opposite VoIP terminal since the previous summary information has been sent (operation S210). The received summary information includes the time when the opposite VoIP terminal sends the summary information and numbers of bytes and packets of traffic sent after the previous summary information was sent.

To obtain the correct time to send the summary information, all VoIP terminals communicate an NTP server in the middle using NTP and set the present time accurately, with an error less than 20 ms. Thus, time information is synchronized between both VoIP terminals. The VoIP terminal receiving the summary information calculates transmission delay by comparing the time of sending the summary information and the time of receiving the summary information, calculates a transmission delay variance by comparing the currently calculated transmission delay value with the just previous transmission delay value, and calculates the lost traffic bytes and packet bytes by comparing the numbers of bytes and packets of the sent traffic with the numbers of bytes and packets of traffic that has been received since the last summary information was received (operation S220).

Then, the speech quality of a call lasting from the instant when the just previous summary information is received until the current summary information is received is evaluated by using the calculated information (operation S230). That is, the speech quality of a particular time interval of a VoIP call is obtained. When it is assumed that a value of the obtained speech quality is A, the speech quality may be expressed by the mean opinion score (MOS), in which a resulting value is represented by a single number in the range 1 to 5, and thus A can be any number between 1 to 5. Accurate MOS value of voice traffic can be obtained according to ITU-T G. 107 standard.

The calculated MOS value, A, is stored in a data structure in the form of a histogram. When the data structure is expressed as HIST, a value of HIST [A], that is, a value of Ath element in the HIST array is increased by one, and MOS values in the next time intervals are correspondingly recorded. When the voice call is finished, the values stored in the HIST are converted into a format that can be transmitted to the outside of the VoIP terminal (operation S240).

The speech quality evaluated according to the above-described procedures is the result of measuring the speech quality of a VoIP traffic in a receiving side. That is, the speech quality of a VoIP traffic in a sending side is assessed through the above-described procedures by the VoIP terminal in the receiving side. Therefore, by gathering the results of the measured speech quality of a VoIP call in both VoIP terminals, the two-way speech quality can be obtained.

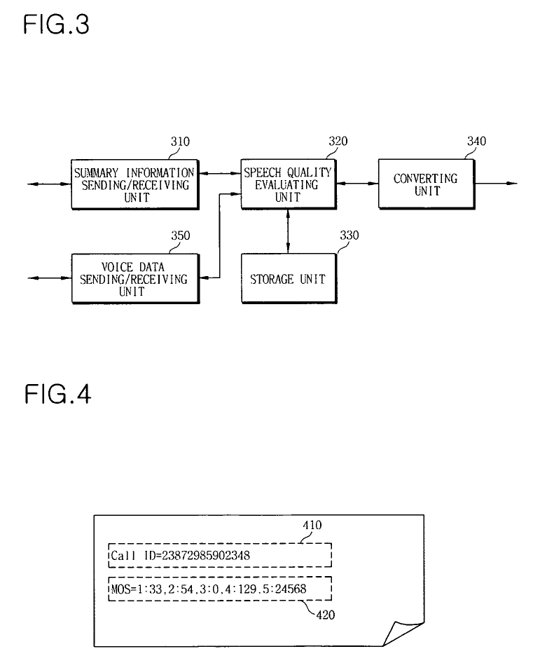

FIG. 3 is a block diagram of an apparatus for measuring speech quality of a VoIP call according to an embodiment of the present invention. Referring to FIG. 3, the apparatus includes a summary information sending/receiving unit 310, a speech quality evaluating unit 320, a storage unit 330, a converting unit 340, and a voice data sending/receiving unit 350.

A VoIP terminal periodically sends an opposite VoIP terminal summary information regarding traffic that the VoIP terminal sends from the time of initiating a call until the end of the call, and the summary information sending/receiving unit 310 receives summary information sent from the opposite VoIP terminal. Moreover, the summary information sending/receiving unit 310 sends the summary information regarding the traffic that the VoIP terminal sends to the opposite VoIP terminal. The received summary information includes the time at which the opposite VoIP terminal sends the summary information, and the numbers of bytes and packets of traffic that is sent after the previous summary information was sent.

The speech quality evaluating unit 320 calculates transmission delay by comparing the time when the summary information was sent with the time at which the summary information was received, and calculates a transmission delay variance by comparing the calculated transmission delay value with the just previous transmission delay value. The speech quality evaluating unit 320 compares the numbers of bytes and packets of voice traffic included in the sent summary information with the numbers of bytes and packets of traffic that has been actually received through the voice data sending/receiving unit 350 since the last summary information was received in order to calculate a number of lost traffic bytes and a number of lost packets. Then, the speech quality of the voice call is evaluated by using the calculated pieces of information, the voice call lasting from the instant the just previous summary information was received until the current summary information is received. The speech quality may be evaluated, for example, according to MOS.

Meanwhile, the received summary information and the evaluated speech quality are stored in the storage unit 330. The storage unit 330 stores the evaluated speech quality value in a data structure in the form of a histogram. The converting unit 340 converts the values stored in the storage unit 330 into a format that can be transmitted to the outside of the VoIP terminal. A specific example of the conversion will now be described with reference to FIG. 4.

FIG. 4 shows an example of converting a result of measuring speech quality of a VoIP call into a format for external transmission of data according to an embodiment of the present invention. Referring to FIG. 4, it is noted that a converting result, which has been obtained by converting the speech quality measurement result into a format that can be transmitted to the outside, has a call identification (call ID) 410, which is assigned to each call, and a speech quality measurement result 420 included therein.

The call ID 410 is a key value that is used as a standard for collecting speech quality measurement results of each VoIP terminal in order to obtain a two-way speech quality measurement result with respect to the one call, and is the only value that is assigned to all VoIP calls over the same network. The speech quality measurement result 420 is obtained by converting the value included in the data structure HIST described above, and a digit before colon (:) denotes a MOS value and digits after the colon represent the occurrence frequency of the MOS value. These ordered pairs are listed with commas therebetween.

The method of measuring speech quality of a VoIP call according to the present invention can be written as computer programs. Codes and code segments for accomplishing the computer programs can be easily construed by programmers skilled in the art to which the present invention pertains. Also, the programs are stored in a computer readable recording medium, and the method of measuring speech quality of a VoIP call according to the present invention is implemented by a computer that reads and executes the programs. Examples of the computer readable recording medium include magnetic storage media, optical recording media, and carrier waves.

According to the present invention, it is possible to measure speech quality of a VoIP call precisely on a regular interval basis. Moreover, the load on a transport network over which voice data is transmitted is reduced, and thus the scalability of the transport network can be improved.

Additionally, according to the present invention, if there is a problem in speech quality, it can be estimated how long the problem lasts and how frequent the problem occurs, so that the present invention can be utilized as a useful tool for resolving a problem between a service user and a service provider when they have a dispute with each other about the speech quality.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of measuring speech quality of a voice over Internet protocol (VoIP) call, the method comprising:
receiving summary information regarding traffic sent from an opposite VoIP terminal; and
evaluating speech quality by comparing the summary information with actually received information regarding the traffic sent from the opposite VoIP.

2. The method of claim 1, wherein the evaluated speech quality is stored in a data structure in a form of a histogram.

3. The method of claim 1, further comprising:
converting the stored speech quality into a format that can be transmitted to the outside in a manner that the converted speech quality includes a call identification (call ID), which is assigned to each voice call, and a speech quality measurement result.

4. The method of claim 3, further comprising:
converting the stored speech quality into a format that can be transmitted to the outside in a manner that the converted speech quality further includes an occurrence frequency of an measurement result indicated by a corresponding value of each speech quality measurement result.

5. The method of claim 1, wherein the summary information includes a time at which the opposite VoIP terminal receives the summary information, and the numbers of bytes and packets of traffic that has been received from the opposite VoIP terminal since the last summary information was received.

6. The method of claim 1, wherein in the evaluating of the speech quality, a transmission delay time is calculated by comparing a time at which the opposite VoIP terminal sends the summary information with a time at which the receiving VoIP terminal receives the summary information, a transmission delay variance is calculated by comparing the calculated transmission delay with a previous transmission delay and the lost bytes and packets of traffic are calculated by comparing the numbers of bytes and packets of the sent traffic with the numbers of bytes and packets of traffic that has been received since the previous summary information was received.

7. The method of claim 6, wherein the evaluation result of the speech quality is indicated by a mean opinion score (MOS) value.

8. The method of claim 1, wherein each VoIP terminal communicates with a network time protocol (NTP) server using NTP to set the present time in advance.

9. An apparatus for measuring speech quality of a VoIP call, the apparatus comprising:
a summary information receiving unit which receives summary information regarding traffic sent from an opposite VoIP terminal; and
a speech quality evaluating unit which evaluates the speech quality by comparing the received summary information with actually received information of the traffic sent from the opposite VoIP terminal.

10. The apparatus of claim 9, further comprising:
a storage unit which stores the evaluated speech quality in a data structure in a form of a histogram.

11. The apparatus of claim 9, further comprising:
a converting unit which converts the stored speech quality into a format that can be transmitted to the outside in a manner that the converted speech quality includes a call ID, which is assigned to each voice call, and a speech quality measurement result.

12. The apparatus of claim 9, wherein the speech quality evaluating unit calculates a transmission delay time by comparing a time at which the opposite VoIP terminal sends the summary information with a time at which the receiving VoIP terminal receives the summary information, calculates a transmission delay variance by comparing the calculated transmission delay with a previous transmission delay and calculates the lost bytes and packets of traffic by comparing the numbers of bytes and packets of the sent traffic with the numbers of bytes and packets of traffic that has been received since the previous summary information was received.
